(19) United States
(12) Patent Application Publication
(10) Pub. No.: US 2004/0166327 A1
(43) Pub. Date: Aug. 26, 2004

(54) Color conversion filter substrate, color conversion type multicolor display having the same, and method of manufacturing the same

(76) Inventors: Makoto Utsumi, Kanagawa (JP); Koji Kawaguchi, Kanagawa (JP)

Correspondence Address: KANESAKA AND TAKEUCHI, 1423 Powhatan Street, Alexandria, VA, 22314, US

(21) Appl. No.: 10/368,406

(22) Filed: Feb. 20, 2003

(51) Int. Cl. B32B 17/06

(52) U.S. Cl. 428/426

(57) ABSTRACT

A color conversion filter substrate includes a transparent support substrate; a single type or a plurality of types of color conversion filter layers formed of a resin film containing a fluorescent colorant and formed on the support substrate in a desired pattern; a polymeric layer formed of a transparent material and having a flat surface for covering the color conversion filter layer; and a transparent inorganic layer formed on the polymeric layer. The inorganic layer contains silicon and at least one of oxygen and nitrogen and has a hydrogen-to-silicon atomic ratio less than 1.

### BACKGROUND OF THE INVENTION AND RELATED ART STATEMENT

The present invention relates to a color conversion filter substrate with good environmental resistance and high productivity for displaying multiple colors with high definition, and to an organic multicolor emitting display device provided with such a filter substrate. More specifically, the present invention relates to a color conversion filter substrate and an organic multicolor emitting display device provided with such a filter substrate for a display of electronic and electric equipment such as an image sensor, a personal computer, a word processor, a television, a fax machine, an audio equipment, a video equipment, a car navigation system, an electric desk top calculator, a telephone, a portable terminal, or an industrial instrument. Especially, the present invention relates to an organic multicolor emitting display device using a color conversion method.

In recent years, the information technology has been diversified. Among elements used in the information technology, display devices including solid imaging devices have been required to have a better aesthetic appearance, a lighter weight, a thinner thickness and higher performance. Furthermore, a great effort has been made to reduce power consumption and increase a response speed. In particular, many attempts have been made to develop high-definition full-color display devices.

In the second half of the 1980s, an organic electroluminescence (hereinafter referred to as ‘organic EL’) device with an organic molecule thin-layered structure has been developed as a device having higher contrast, constant-voltage driving, wider angle visibility, and faster response as opposed to a liquid crystal display device. Tang et al. reported that an organic EL formed of stacked thin films of organic molecules showed a high luminance of 1000 cd/m² at an applied voltage of 10 V (Appl. Phys. Lett., 51, 913 (1987)). This stacked organic EL device has excellent characteristics such as a wide view angle and a quick response time compared to liquid crystal display devices. After the report by Tang et al., a great effort has been made to develop organic EL devices for a practical use. Attempts have also been made to develop similar devices composed of an organic polymer material.

Since the organic EL device provides a high current density at a low voltage, it is expected to provide higher emission luminance and efficiency as opposed to inorganic EL devices and LEDs.

The organic EL display device is expected to have characteristics such as (1) high luminance and high contrast, (2) low driving voltage and high emission efficiency, (3) high resolution, (4) wide angle visibility, (5) high response speed, (6) possibility of increasing definition and providing color displays, (7) reduced weight and reduced thickness, and the like. Thus, the organic EL device is expected to have a better aesthetic appearance, a lighter weight, a thinner thickness and higher performance.

Tohoku Pioneer Corporation has already developed products including vehicle-mounted green monochrome organic EL displays since November 1997. In order to meet the society needs, it is desirable to develop improved organic EL displays that are stable for an extended period of time, respond quickly, and display multiple colors or full colors with high definition.

There have been three major approaches as a method of displaying multiple or full colors with the organic EL display. One of the methods has been disclosed in Japanese Patent Publications No. 57-167487, No. 58-147989, and No. 03-214593, in which light emitting elements of the three primary colors (red, green, and blue) are arranged in a matrix form. In this method, it is necessary to arrange three types of light-emitting materials (R, G, and B) in a matrix form with high precision, thereby making it technically difficult to produce and increasing a cost. Further, the three types of light-emitting materials have different life times, thereby shifting a color of the display with time.

As the second approach, in Japanese Patent Publications No. 01-315988, No. 02-273496, and No. 03-194895, a method in which a color filter and a backlight emitting white light are used to display the three primary colors through the filter has been disclosed. However, it is difficult to obtain an organic light emitting device emitting the bright white light with a long life, which is necessary for obtaining bright three colors R, G, and B.

Recently, Japanese Patent Publication No. 03-152897 has disclosed another method in which phosphors arranged on a plane absorb light from light emitting devices, so that the phosphors emit fluorescence in multiple colors. Such a method using a certain luminous device to allow the phosphors to emit fluorescence in multiple colors has been applied to CRTS, plasma displays, and the like.

Further, in recent years, a color conversion method has been proposed in which a filter is composed of a fluorescent material for absorbing light with a wavelength in a light-emission region of an organic light emitting device, so that the fluorescent material emits fluorescence with a wavelength in a visible light region (Japanese Patent Publications No. 03-152897 and No. 05-258860). In this approach, an organic light emitting device that emits a color other than white can be used. Therefore, it is possible to use an organic light emitting device with higher brightness as a light source. In a color conversion method using an organic light emitting device emitting blue light (Japanese Patent Publications No. 03-152897, No. 08-286033, and No. 09-208944), a frequency of blue light is converted to that of green or red light. A color conversion filter containing a fluorescent material with such color conversion effect may be formed in a high-resolution pattern. Accordingly, it is possible to provide a full-color light emitting display even with weak energy light such as near-ultraviolet light or visible light.

In order to form a pattern of a color conversion filter, a method in which a pattern is formed with a photolithography process after a film of a resist (photosensitive polymer) material containing fluorescent material is prepared by spin-coating has been disclosed in Japanese Patent Publications No. 05-198921 and No. 05-258860. Also, Japanese Patent Publication No. 09-208944 has disclosed a process in which a fluorescent material or fluorescent pigment is dispersed in a basic binder followed by etching the binder with an acid solution.

In general, it is important for a practical color display to possess high-resolution color and long-term stability, as described in KinohZairyo Vol. 18, No. 2, 96. However, the organic EL devices tend to markedly lose light-emission characteristics such as current-luminance characteristics after a specific period of time.

A major cause of the degraded light-emission characteristics is a growth of dark spots in the light-emitting layer. The dark spots are formed of light-emission defects. When the fluorescent material in the light-emitting layer is oxidized while using or storing the organic EL device, the dark spots grow and spread over the entire light-emitting surface. It is believed that the dark spots are created by oxidation or aggregation of a material constituting a layered device caused by oxygen or moisture in the device. The dark spots grow not only when electricity is conducted but also during storage. In particular, it is believed that (1) the growth is accelerated by oxygen or moisture present around the device, (2) the growth is affected by oxygen or moisture attached to the organic stacked films, and (3) the growth is affected by moisture attached to parts or entered in the device when the device is manufactured.

As shown in FIG. 2, in the color conversion multicolor organic EL display, the color conversion filters 2, 3, and 4 are disposed under the transparent electrode 7. As described above, the color conversion filter is formed of the resin containing the colorant for color conversion. Because of thermal stability of the colorant, it is not possible to dry the color conversion filter at a temperature above 200° C. Accordingly, it is likely that the color conversion filters contain moisture from a coating liquid or enters during a pattern-forming process. The moisture in the color conversion filters passes through the polymeric layer to the device while the device is stored or is continuously operated, thereby facilitating the growth of the dark spots.

In order to prevent moisture from entering the organic EL device, Japanese Patent Publication No. 08-279394 has disclosed an approach in which an insulating inorganic oxide layer with a thickness of 0.01 to 200 μm is provided between the color conversion filter layers and the organic EL device. The inorganic oxide layer is required to have high moisture resistance for maintaining the life of the organic light-emitting layer. It is preferable that the inorganic oxide layer has coefficients of the gas permeability for both water vapor and oxygen less than 10⁻¹³ cc·cm/cm²·s·cmHg according to the gas permeability test method in JIS K7126.

As disclosed in Japanese Patent Publications No. 07-146480 and No. 10-10518, in a method of forming the color filter, SiOx or SiNx is formed on a polymeric layer formed on the color filter layer with a DC sputtering, thereby improving adhesion of the transparent electrode layers. Japanese Patent Publication No. 2000-214318 has disclosed a method in which a low melting point glass is used. Also, Japanese Patent Publication No. 2000-223264 has disclosed a method in which a SiNx layer is formed with a CVD method to seal the organic EL device from atmosphere.

As shown in FIG. 2, in the color conversion multicolor organic EL display, the inorganic layer, the polymeric layer and the color conversion filter are disposed under the transparent electrode 7. As described above, because of the thermal stability of the colorant in the color conversion filter, it is not possible to process the color conversion filter at a temperature above 200° C. Accordingly, it is necessary to process all layers on the color conversion filter at a process temperature below 200° C.

Sputtering is a method of forming the inorganic layer that satisfies the restriction on the process temperature described above. For example, in the case of forming SiOx, it is possible to use (1) a method in which a Si target is used, argon and oxygen gases are introduced, and an RF voltage is applied, or (2) a method in which a quartz target is used, argon gas is introduced, and an RF voltage is applied. A SiOx film formed with such a method has an excellent visible light transmittance and good adhesion as a protective film for an optical disk and the like.

However, the sputtering does not provide a good coverage in forming the film. For example, in a case that a polymeric film as a base does not have a flat surface and has large undulations due to dusts and the like, it is difficult to obtain a good coverage as the sputtering particles do not reach underneath, resulting in poor moisture resistance. In addition, without a heating process, it is difficult for the sputtered particles attached to the substrate to migrate, thereby worsening the coverage compared to a case with the heating process.

Further, in the sputtering process, the film deposition rate is low, resulting in a poor productivity. When a plurality of sputtering chambers is used to improve the productivity, the equipment cost becomes high.

The present invention has been made in view of the problems described above. It is an object of the present invention to provide a multicolor organic EL display with stable light emission characteristics for a long period of time, and a method of efficiently forming such an organic EL device.

Further objects and advantages of the invention will be apparent form the following description of the invention.

### SUMMARY OF THE INVENTION

According to the first aspect of the present invention, a color conversion filter substrate comprises a transparent support substrate; a single type or a plurality of types of color conversion filter layers formed of a resin film containing a fluorescent colorant and formed on the support substrate in a desired pattern; a polymeric layer formed of a transparent material and having a flat surface for covering the color conversion filter layers; and a transparent inorganic layer formed on the polymeric layer. The inorganic layer contains silicon and at least one of oxygen and nitrogen and has a hydrogen-to-silicon atomic ratio less than 1.

According to the second aspect of the present invention, a color conversion type multicolor display comprises the color conversion filter substrate according to the first aspect. Further, a transparent electrode layer formed at one or more electrically independent regions, a light-emitting layer containing a light-emitting material, and the second electrode layer are formed in this order on the color conversion filter substrate.

According to the third aspect of the present invention, a method of manufacturing a color conversion filter substrate comprises at least a step of preparing a transparent support substrate; a step of forming a single type or a plurality of types of color conversion filter layers formed of a resin film containing a fluorescent colorant on the support substrate in a desired pattern; a step of covering the color conversion filter layers with a polymeric layer formed of a transparent material and having a flat surface; and a step of forming a transparent inorganic layer containing silicon and at least one of oxygen and nitrogen and having a hydrogen-to-silicon atomic ratio less than 1 on the polymeric layer. The step of forming the inorganic layer is carried out by using a plasma CVD method at a temperature less than 200° C., and using raw material gases containing at least a gas selected from the group consisting of silane and tetraethoxysilane, and a gas selected from the group consisting of nitrogen, ammonia, oxygen, nitrogen oxide and carbon dioxide.

According to the fourth aspect of the present invention, in the method according to the third aspect, the step of forming the inorganic layer is carried out in a state that the support substrate has a potential lower than an earth potential.

According to the fifth aspect of the present invention, a method of manufacturing a color conversion type multicolor display comprises at least a step of preparing a transparent support substrate; a step of forming a single type or a plurality of types of color conversion filter layers formed of a resin film containing a fluorescent colorant on the support substrate in a desired pattern; a step of covering the color conversion filter layers with a polymeric layer formed of a transparent material and having a flat surface; a step of forming a transparent inorganic layer containing silicon and at least one of oxygen and nitrogen and having a hydrogen-to-silicon atomic ratio less than 1 on the polymeric layer; a step of forming a transparent electrode layer at one region or a plurality of electrically independent regions on the inorganic layer; a step of forming a light-emitting layer containing at least a light-emitting material on the transparent electrode layer; and a step of forming the second electrode layer on the light-emitting layer. The step of forming the inorganic layer is carried out using a plasma CVD method at a temperature less than 200° C., and using raw material gases containing at least a gas selected from the group consisting of silane and tetraethoxysilane, and a gas selected from the group consisting of nitrogen, ammonia, oxygen, nitrogen oxide and carbon dioxide.

According to the sixth aspect of the present invention, in the method according to the fifth aspect, the step of forming the inorganic layer is carried out in a state that the support substrate has a potential lower than an earth potential.

### BRIEF DESCRIPTION OF THE DRAWINGS

FIG. 1 is a schematic diagram showing a sectional view of a color conversion filter substrate; and

FIG. 2 is a schematic diagram showing a sectional view of an organic EL multicolor display device using a color conversion filter substrate according to the present invention.

### DETAILED DESCRIPTION OF PREFERRED EMBODIMENTS

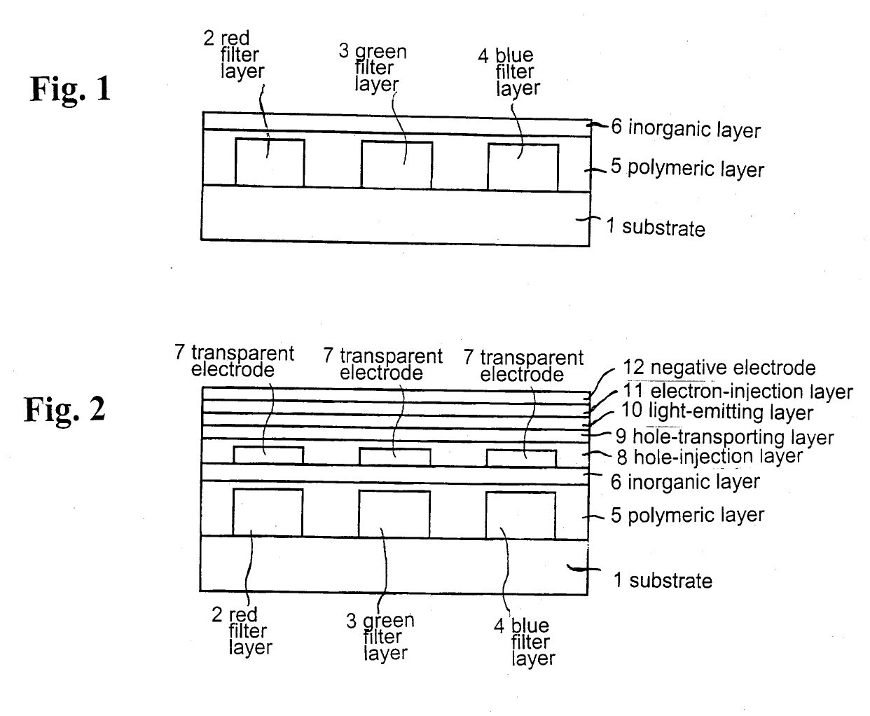

An example of a color conversion filter substrate of the present invention is shown in FIG. 1. In FIG. 1, a red color conversion filter layer 2, a green color conversion filter layer 3 and a blue color conversion filter layer 4 are formed on a support substrate 1 in a specific pattern. As described later, the green color conversion filter layer 3 may be a green filter layer. Moreover, the blue color conversion filter layer 4 is preferably a blue filter layer. A polymeric layer 5 is covering the color conversion filter layers, and an inorganic layer 6 is formed thereon and has a flat upper surface. The following is a detailed description of each of the layers.

In the present invention, an organic fluorescence colorant constituting a color conversion filter layer absorbs light with a wavelength in a near-ultraviolet or visible region emitted by a luminous device, especially light with a wavelength in a blue or bluish green region, to emit another visible light. It is preferred that one or more types of fluorescence colorants emitting at least fluorescence with a wavelength in the red region are used, and may be combined with one or more types of fluorescence colorants emitting fluorescence with a wavelength in a green region.

In a case that an organic light emitting device that emits light with a wavelength in the blue or bluish-green region is used, when the light is converted to light with a wavelength in the red region through a simple red filter, an intensity of the light is greatly reduced due to a small amount of red light in the original light. It is possible to obtain high intensity light with a wavelength in the red region by using a fluorescence colorant to convert light from the organic light emitting device into light with a wavelength in the red region.

It is possible to obtain light with a wavelength in the green region by using another organic fluorescence colorant to convert light from the organic light emitting device into light with a wavelength in the green region. Alternatively, the light from the light emitting device may pass through a green filter to obtain green light when the light from the organic light emitting device contains a sufficient amount of light with a wavelength in the green region.

As for light with a wavelength in the blue region, an organic fluorescence colorant may be used to convert light from the organic light emitting device. It is preferred that the light from the organic light emitting device passes through a blue filter to obtain light with a wavelength in the blue region.

The fluorescence colorants that absorb light with a wavelength in the blue or bluish-green region emitted from the luminous device to emit fluorescence with a wavelength in the red region include, for example, rhodamine-based colorants such as rhodamine B, rhodamine 6G, rhodamine 3B, rhodamine 101, rhodamine 110, sulforhodamine, basic violet 11, and basic red 3, cyanine-based colorants, pyridine-based colorants such as 1-ethyl-2-(4(p-dimethylaminophenyl)-13-butadienyl)-pyridium-perchlorate (pyridine 1), and oxazine-based colorants. Furthermore, various dyes (direct dyes, acid dyes, basic dyes, disperse dyes, etc.) can be used provided that they are fluorescent.

The fluorescence colorants that absorb light with a wavelength in the blue or bluish-green region emitted from the luminous device to emit fluorescence with a wavelength in the green region include, for example, coumarin-based colorants such as 3-(2′-benzothiazolyl)-7-diethylaminocoumarin (coumarin 6), 3(2′-(benzimidazolyl)-7-N,N-diethylaminocoumarin (coumarin 7), 3(2′-N-methylbenzimidazolyl)-7-N,N-diethylaminocoumarin (coumarin 30), and 2,3,5,6-1H,4H-tetrahydro-8-trifluoromethylquinolizino (9,9a,1-gh) coumarin (coumarin 153), basic yellow 51 as a coumarin colorant-based dye, and naphthalimide-based colorants such as solvent yellow 11 and solvent yellow 116. Furthermore, various dyes (direct dyes, acid dyes, basic dyes, disperse dyes, etc.) can be used provided that they are fluorescent.

The organic fluorescence colorants may be formed in an organic fluorescent pigment by blending in advance into a resin such as polymethacrylate, polyvinyl chloride, vinyl chloride-vinyl acetate copolymer, alkyd resin, aromatic sulfonamide resin, urea resin, melamine resin, benzoguanamine resin, and a mixture of these resins. Further, these types of organic fluorescence colorants or organic fluorescent dyes (in the specification, these are collectively referred as organic fluorescence colorants) may be used solely, or two or more types of such colorants may be combined together in order to adjust hue of the fluorescence.

According to the present invention, the device contains 0.01 to 5 wt %, more preferably 0.1 to 2 wt %, of such an organic fluorescence colorant with reference to a weight of a fluorescence color conversion film. When the device contains less than 0.01 wt % of the organic fluorescence colorant, wavelength conversion is not sufficient. When the device contains more than 5 wt % of the organic fluorescence colorant, the color-conversion efficiency may be decreased due to a concentration quenching effect or the like.

A matrix resin used for the fluorescence color conversion filter layers is a photo-setting or photo- and thermo-setting resin. The matrix resin is cured optically and/or thermally to generate radicals or ion seeds to polymerize and cross-link, thereby obtaining a material that is not soluble and does not melt. It is preferred that the photo-setting resin or photo- and thermo-setting resin is soluble in an organic solvent or an alkali solution before curing so that the fluorescence color conversion film is formed in a pattern.

The photo-setting resin or photo- and thermo-setting resin includes (1) a composition containing an acrylic multifunctional monomer/oligomer having acroyl groups or methacroyl groups and a photo- or thermo-polymerization initiator, wherein the composition is optically or thermally treated to generate optical or thermal radicals for polymerization, (2) a composition containing polyvinyl ester cinnamate and a sensitizer, wherein the composition is thermally treated to produce dimers for cross-linking, (3) a composition containing a linear or cyclic olefin and bisazido, wherein the composition is optically or thermally treated to generate nitrene to cross-link with the olefin, or (4) a composition containing monomers having an epoxy group and a photo oxidizer, wherein the composition is optically or thermally treated to generate acids (cations) for polymerization. In particular, the photo-setting resin or photo- and thermo-setting resin of (1) provides high resolution and easy pattern formation, as well as good solvent- and heat-resistance and the like. As described above, the photo-setting resin or photo- and thermo-setting resin is exposed to light, or is subjected under heat to form the matrix resin.

It is preferred that the photo-polymerization initiator used in the present invention initiates the polymerization by light with a wavelength that the fluorescence pigment contained in the initiator does not absorb. In the light conversion layer according to the present invention, when the photo-setting resin or photo- and thermo-setting resin itself can be polymerized by light or heat, the photo- or thermo-polymerization initiator may be omitted.

A solution or dispersion of the resin is applied to a support substrate to form a resin layer. Then, a desired portion of the photo-setting or photo- and thermo-setting resin is exposed for polymerization to form the matrix resin. After the desired portion of the photo-setting or photo- and thermo-setting resin is exposed to become insoluble, the resin is formed in a pattern. A patterning step includes a conventional method in which an unexposed portion of the resin is removed by using an organic solvent or alkali solution that dissolves or disperses the resin.

A material for the polymeric layer 5 has high transparency in the visible region (permeability of 50% or greater at a wavelength of 400 nm to 700 nm), a Tg of 100° C. or higher, and a surface hardness of 2H or greater in terms of pencil hardness. The material is formed in a smooth coating film in a order of μm on the color conversion filter, and does not affect the functionality of the color conversion filter layers 2˜4. Such a material includes a photo-setting resin and/or a thermo-setting resin such as an imide modified silicone resin (Japanese Patent Publications No. 05-134112, No. 07-218717, and No. 07-306311), an inorganic metal compound (TiO, Al₂O₃, SiO₃, or the like) dispersed in an acrylic, polyimide, silicone, or other resin (Japanese Patent Publications No. 05-119306 and No. 07-104114), an epoxy-modified acrylatol resin used as an ultraviolet curable resin (Japanese Patent Publication No. 07-48424), a resin having reactive vinyl groups of acrylate monomer/oligomer/polymer, or a resist resin (Japanese Patent Publications No. 06-300910, No. 07-128519, No. 08-279394, and No. 09-330793), or a fluorine-based resin (Japanese Patent Publications No. 05-36475 and No. 09-330793). The polymeric layer 5 may be formed of an inorganic compound formed by a sol-gel process (Monthly Display, Vol. 3, No. 7, 1997, Japanese Patent Publication No. 08-27394).

The polymeric layer 5 can be formed with various methods. For example, the layer may be formed with a conventional method such as a dry process (sputtering, vapor deposition, CVD, or the like) or a wet process (spin coating, roll coating, casting, or the like).

The inorganic layer 6 is preferably formed of a material that is electrically insulating, acts as a barrier against gases and organic solvents, has high transparency in the visible region (a transmittance of at least 50% in a range of 400 to 700 nm), and has a hardness sufficient to withstand during a forming process of the transparent electrode layer 7 onto the inorganic layer 6, preferably a pencil hardness at least 2H. For example, a material that contains silicon and at least one of oxygen and nitrogen, namely SiOx:H (i.e. silicon oxide which may contain hydrogen as an impurity), SiNx:H or SiOxNy:H, or a material comprising SiOx and a metal such as Al can be used as the inorganic layer. It is preferable to use the CVD method as the method of forming the inorganic layer 6.

The inorganic layer 6 may be a single layer, or a plurality of layers stacked on top of the another.

The formation of the inorganic layer can be carried out by using a plasma CVD method at a temperature less than 200° C., and using raw material gases containing at least a gas selected from the group consisting of silane and tetraethoxysilane, and a gas selected from the group consisting of nitrogen, ammonia, oxygen, nitrogen oxides and carbon dioxide. A preferable nitrogen oxide is N₂O.

In forming the SiOx film as the inorganic layer 6, it is possible to use (1) the plasma CVD method using tetraethoxysilane (TEOS) and oxygen as the raw material gas with an oxygen/TEOS flow ratio of 5 to 80, a film deposition pressure of 1 to 50 Pa, and a film deposition electrical power of approximately 100 to 500 W, (2) the plasma CVD method using silane and N₂O as the raw material gases with an N₂O/silane flow ratio of 5 to 50, a film deposition pressure of 1 to 20 Pa, and a film deposition electrical power of approximately 100 to 500 W, or (3) the plasma CVD method using silane and carbon dioxide as the raw material gases. In particular, in the case of using silane as the raw material gas, it is possible to reduce a residual amount of by-products such as nitrogen and hydrogen derived from the raw material gas in the film, thereby improving the moisture resistance.

In forming the SiNx film as the inorganic layer 6, it is possible to use (1) the plasma CVD method using silane and nitrogen as the raw material gases with a nitrogen/silane flow ratio of 5 to 80, a film deposition pressure of 1 to 20 Pa, and a film deposition electrical power of approximately 100 to 500 W, or (2) the plasma CVD method using silane and ammonia as the raw material gases with an ammonia/silane flow ratio of 5 to 30, a film deposition pressure of 1 to 50 Pa, and a film deposition electrical power of approximately 100 to 500 W. In particular, when the SiNx film is used, it is possible to provide lower moisture permeability as opposed to the SiOx film.

In forming the SiOxNy film as the inorganic layer 6, the plasma CVD method can be used by using TEOS and nitrogen, or TEOS and N₂O as the raw material gases.

In any of the methods described above, a film deposition rate can be at least 20 nm/minute. At this rate, the inorganic layer 6 of the present invention can be deposited quickly, thereby improving the productivity.

In order to evaluate the moisture resistance of the inorganic layer 6 formed as described above, an etching rate in a mixture of hydrofluoric acid, nitric acid and pure water (mixing ratio 3:2:60 by volume) at 25° C. is determined. When the inorganic layer has a lower hydrogen content, the etching rate becomes slower, indicating better moisture resistance.

A mean atomic ratio in the inorganic layer 6 can be determined by Rutherford backscattering spectrometry (RBS). With the RBS, high-energy He ions are spiked into a solid, and an energy of scattered He ions through elastic collisions between atomic nuclei (Rutherford scattering) is measured to obtain information on an elemental distribution in the solid.

According to the evaluation, when the color conversion filter substrates and the color conversion type multicolor displays having these color conversion filter substrates showed sufficient moisture resistance, SiOx, SiNx and SiOxNy films all had a hydrogen-to-silicon mean atomic ratio (H/Si) less than 1.

In order to attain such a hydrogen-to-silicon mean atomic ratio, the amount of the residual hydrogen in the inorganic layer may be reduced through promoting decomposition of the raw material gases. To this end, an RF voltage is applied to the substrate side so that the substrate has a negative potential, thereby forming a sheath region around the substrate surface. Then, the ionized raw material gases collide with the substrate in a high-energy state. The RF voltage applied to the substrate is preferably 100 to 500 V at a frequency of 13.56 MHz.

Plasma can be generated and maintained with any of the discharging methods including a capacitive coupling method, an inductive coupling method, and a microwave discharge method.

In the color conversion filter according to the present invention, the support substrate 1 needs to be transparent with respect to light converted by the color conversion layers 2 to 4. Further, the support substrate 1 needs to withstand conditions (solvent, temperature, and the like) in the process of forming the color conversion layers 2 to 4 and the polymeric layer 5, and moreover, the support substrate 1 is preferably dimensionally stable.

A preferable material for the support substrate 1 includes such a resin as polyethyleneterephthalate and polymethylmethacrylate. A Corning glass is particularly preferable.

According to the present invention, one or more types of color conversion films are formed on the support substrate 1 in a desired pattern to form the color conversion filter. A composition containing the fluorescence pigment and resist is applied on the support substrate 1, and is exposed to the light through a mask of the desired pattern to form the pattern. The color conversion layers have a thickness more than 5 μm, preferably 8 to 15 μm.

In producing the color display, three types of color conversion films for red, green, and blue are preferably formed. In a case that a luminous device emitting blue or bluish-green light is used, it is possible to form red and green color conversion films and a blue filter layer.

A pattern of the color conversion filter layers and the filter layer depends on an application. A set of rectangular or circular areas for red, green, and blue may be produced over an entire support substrate. Alternatively, a set of adjacent and parallel stripes with a specific width and a length equal to that of the support substrate 1 for red, green, and blue may be produced over the entire support substrate. A color conversion film of a particular color may be formed in a larger area (the number of areas, or a total area) than that of color conversion films of the other colors.

According to the present invention, the color conversion color display includes the color conversion filter substrate and the organic EL luminous device provided on the filter substrate. The organic EL luminous device emits light with a wavelength in the near-ultraviolet or visible region, preferably light with a wavelength in the blue or bluish-green region. The light enters the fluorescence color conversion filter. The light is then output from the fluorescence color conversion filter layer as visible light with a different wavelength.

The organic EL luminous device is structured so as to sandwich an organic luminous layer 10 between a transparent electrode 7 and the second electrode 12. As needed, a hole-injection layer 8, a hole-transport layer 9 and/or an electron-injection layer 10 are interposed between the luminous layers. The luminous device is composed of layers specified below;

(1) Positive electrode/organic light-emitting layer/negative electrode,

(2) Positive electrode/hole-injection layer/organic light-emitting layer/negative electrode,

(3) Positive electrode/organic light-emitting layer/electron-injection layer/negative electrode,

(4) Positive electrode/hole-injection layer/organic light-emitting layer/electron-injection layer/negative electrode,

(5) Positive electrode/hole-injection layer/hole-transporting layer/organic light-emitting layer/electron-injection layer/negative electrode.

In the layer configurations described above, it is preferred that at least one of the positive and negative electrodes is the transparent electrode 7. In the present invention, the positive electrode is desirably transparent.

It is necessary for a material of the transparent electrode layer 7 to efficiently transmit the exciting light emitted by the organic EL device (i.e. light in the near ultraviolet to visible region, preferably blue to blue/green light). ITO (indium-tin oxide) or an In₂O₃-ZnO based material can be used.

FIG. 2 is a view showing an example of the organic EL multicolor display according to the present invention. FIG. 2 shows a single pixel of the organic light emitting device having multiple pixels for displaying in multicolor or full-color. The hole-injection layer 8, the hole-transporting layer 9, the organic light-emitting layer 10, the electron-injection layer 11, and the negative electrode 11 are formed in this order at a location corresponding to the color conversion filter layers 2 to 4 on the transparent electrodes 7 of the color conversion filter substrate.

A material for each of the layers is well known. For example, in a case that the organic light-emitting layer 10 emits light with a wavelength in the blue or bluish-green region, a material includes benzothiazole-, benzimidazole-, benzoxazole-based fluorescent whitening agent, a metal chelated oxonium compound, a styrylbenzene-based compound, and an aromatic dimethylidine compound.

The negative electrode 12 is formed of a metal electrode. The positive and negative electrodes 7 and 12 may be formed in a parallel stripe pattern, or a cross pattern that the positive electrode 7 crosses the negative electrode 12. In a case of the cross pattern, the organic light emitting device of the present invention can be driven in matrix. That is, when a voltage is applied to a particular stripe of the positive electrode 7 and a particular stripe of the negative electrode 12, light is emitted from the point at which these stripes intersect. Accordingly, light can be emitted from a pixel of the organic light emitting device in which a particular fluorescence color conversion film and/or filter layer is located, when a voltage is applied to the selected stripes of the positive and negative electrodes 7 and 12.

Alternatively, the positive electrode 7 may be formed in a uniform plane without a stripe pattern, and the negative electrode 12 may be formed in a pattern corresponding to the pixels. In such a case, switching elements corresponding to the respective pixels may be provided for active matrix driving.

Hereunder, examples to which the inorganic layer of the present invention is applied will be explained with reference to the drawings.

### EXAMPLE 1

(Production of Blue Filter Layer 4) A blue filter material (manufactured by Fuji Hunt Electronics Technology Co., Ltd.; Color Mosaic CB-7001) was coated on a non-alkaline glass (Corning 1737 glass 50×50×1.1 mm) as the transparent substrate 1 with the spin-coating process. The film was then patterned with the photolithography to obtain a pattern of the blue filter layer 4 having a line width of 0.1 mm, a pitch (cycle) of 0.33 mm, and a film thickness of 6 μm.

### Production of Green Conversion Filter Layer 3

Coumarin 6(0.7 parts by weight) as the fluorescent colorant was dissolved into 120 parts by weight of propylene glycol monomethyl ethel acetate (PGMEA) as a solvent. Then, 100 parts by weight of the photo-polymerizing resin “V259PA/P5” (trade name; manufactured by Nippon Steel Chemical Co., Ltd.) was added and dissolved in the mixture to obtain a coating liquid.

The coating liquid was applied to the transparent substrate 1 with the spin-coating process. The resulting film was then patterned with the photolithography to obtain a pattern of the green conversion layer 3 having a line width of 0.1 mm, a pitch (cycle) of 0.33 mm, and a film thickness of 10 μm.

(Production of Red Conversion Filter Layer 2) Coumarin 6 (0.6 parts by weight), rhodamine 6G (0.3 parts by weight), and basic violet 11 (0.3 parts by weight) as the fluorescent colorants were dissolved in 120 parts by weight of PGMEA as a solvent. Then, 100 parts by weight of the photo-polymerizing resin “V259PA/P5” (trade name; manufactured by Nippon Steel Chemical Co., Ltd.) was added and dissolved in the mixture to obtain a coating liquid.

The coating liquid was applied to the transparent substrate 1 with the spin-coating process. The substrate was then patterned with the photolithography to obtain a line pattern of the red conversion layer 2 having a line width of 0.1 mm, a pitch of 0.33 mm, and a film thickness of 10 μm.

The red conversion filter layer 2, green color conversion filter layer 3 and blue filter layers 4 formed as described above were arranged in a pattern of parallel lines with 0.01 mm of gaps therebetween.

### (Production of Polymeric Layer 5)

A UV cure resin (epoxy modified acrylate) was applied to the color conversion layers 2-4 and the color conversion layers with the spin-coating process, and the polymeric layer 5 was formed with the high-power mercury lamp. The polymeric layer 5 has a thickness of 8 μm on each of the color conversion filter layers. At this time, the pattern of the color conversion filter layers was not deformed, and a top surface of the protective layer 5 remained flat.

### Production of Inorganic Layer 6

A SiNx film with a thickness of 240 nm was formed on the polymeric layer 5 with the plasma CVD method, thereby obtaining the color conversion filter substrate. The plasma CVD was carried out at a substrate temperature of 150° C. using silane and nitrogen as the raw material gases with a nitrogen/silane flow ratio of 30, and using a film deposition pressure of 50 Pa and a film deposition electrical power of 500 W.

The hydrogen-to-silicon mean atomic ratio in the inorganic layer 6 was measured with the Rutherford backscattering measurement apparatus (Nissin-High Voltage Co., Ltd.). The hydrogen-to-silicon mean atomic ratio (H/Si) in the inorganic layer 6 formed as described above was approximately 0.9.

### Production of Organic EL device

As shown in FIG. 2, six layers were sequentially stacked on the color conversion filter produced as described above. The six layers included the transparent electrode 7, hole-injection layer 8, hole-transporting layer 9, organic light-emitting layer 10, electron-injection layer 11, and negative electrode 12.

First, the transparent electrode (IDIXO) was formed on the entire top surface of the color conversion filter substrate with the sputtering process. After the resist agent “OFRP-800” (trade name; manufactured by Tokyo Ohka Kogyo Co. Ltd.) was applied to the IDIXO, the resulting layer was patterned with the photolithography, thereby obtaining the transparent electrodes 7 in a stripe pattern with a width of 0.094 mm, a gap of 0.016 mm, and a thickness of 100 nm located at the respective color conversion layers 2 to 4.

The color conversion filter substrate with the transparent electrodes 7 formed thereon was placed in a resistance-heating vapor-deposition apparatus. Then, the hole-injection layer 8, the hole-transporting layer 9, the organic light-emitting layer 10, and the electron-injection layer 11 were sequentially formed on the substrate in a vacuum. During the process of forming the films, an internal pressure of a vacuum chamber was reduced to 1×10⁻⁴ Pa. As the hole-injection layer 8, copper phthalocyanine (CuPc) was stacked in a thickness of 100 nm. As the hole-transporting layer 9, 4,4′-bis(N-(1-naphthyl)-N-phenylamino) biphenyl (α-NPD) was stacked in a thickness of 20 nm. As the light-emitting layer 10, 4,4′-bis(2,2-diphenylvinyl) biphenyl (DPVBi) was stacked in a thickness of 30 nm. Furthermore, as the electron-injection layer 11, aluminum chelate (Alq) was stacked in a thickness of 20 nm. Chemical structures of the materials used for these layers are shown in Table 1 below.

TABLE 1

| Layer configuration | Material | Chemical Structure |
|---|---|---|
| Hole-injection layer | Copper phthalocyanine | 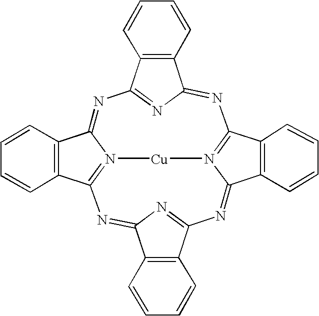 |
| Hole-transporting layer | 4,4′-bis(N-(1-naphthyl)-N- phenylamino) biphenyl | 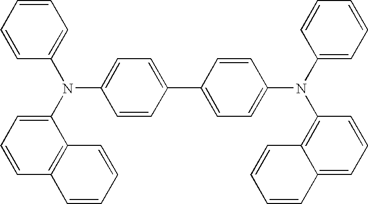 |
| Light-emitting layer | 4,4′-bis(2,2-diphenylvinyl) biphenyl | 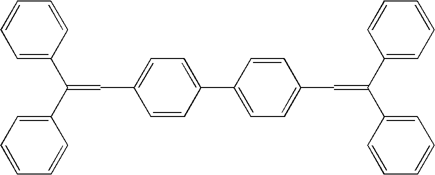 |
| Electron- transporting layer | Tris (8-hydroxyquinoline) aluminum complex | 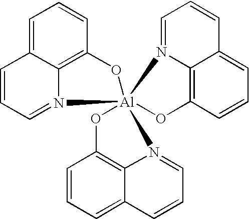 |

Then, the negative electrode 12 consisting of an Mg/Ag (weight ratio: 10 to 1) layer with 200 nm of a thickness was formed by using a mask of a stripe pattern with a width of 0.30 mm and a gap of 0.03 mm perpendicular to the stripes of the positive (transparent) electrodes 7 in the vacuum. The organic multicolor light emitting device thus obtained was sealed in a glove box under a dry-nitrogen atmosphere (oxygen and moisture, both with a concentration of 10 ppm or less) using a sealing glass (not shown) and a UV cure adhesive.

### EXAMPLE 2

A multicolor organic EL display was manufacture by using the same method as in Example 1, except that the inorganic layer 6 was manufactured by using the method described below.

A film was deposited with the plasma CVD in which silane and nitrogen were used as the raw material gases with a nitrogen/silane flow ratio of 30, a film deposition pressure was 50 Pa, a film deposition electrical power was 500 W, and a substrate temperature was 80° C. After approximately 10 seconds from the start of the deposition, an RF voltage with an electrical power of 100 W was applied to the substrate. A SiNx film having a thickness of 240 nm was formed to obtain the inorganic layer 6.

The hydrogen-to-silicon mean atomic ratio in the inorganic layer 6 of this sample was measured by using a Rutherford backscattering measurement apparatus (made by Nissin-High Voltage Co., Ltd.). The hydrogen-to-silicon mean atomic ratio (H/Si) in the inorganic layer 6 formed as described above was determined to be approximately 0.3.

### COMPARATIVE EXAMPLE 1

A multicolor organic EL display was manufactured by using the same method as in Example 1, except that the inorganic layer 6 was manufactured by using the method described below.

A film was deposited with the plasma in which silane and nitrogen were used as the raw material gases with a nitrogen/silane flow ratio of 30, a film deposition pressure was 50 Pa, a film deposition electrical power was 500 W, and a substrate temperature was 80° C. A SiNx film having a thickness of 240 nm was formed to obtain the inorganic layer 6.

The hydrogen-to-silicon mean atomic ratio in the inorganic layer 6 of this sample was measured by using a Rutherford backscattering measurement apparatus (made by Nissin-High Voltage Co., Ltd.). The hydrogen-to-silicon mean atomic ratio (H/Si) in the inorganic layer 6 formed as described above was determined to be approximately 1.2.

### Evaluation of the multicolor organic EL displays

Three displays were manufactured in accordance with each of Examples 1 and 2 and Comparative Example 1, and driving tests were carried out. The driving was carried out through line-sequential scanning with a driving frequency of 60 Hz, a duty ratio of 1/60, and a current per pixel of 2 mA for 100 hours. Then, the number of dark spots per unit area on the display was determined. The results are shown below in Table 2.

TABLE 2

| | Number of | |
|---|---|---|
| | dark spots | |
| | per unit | |
| Sample | area (1 cm²) | Ratio |
| Example 1 | 0.55 ± 0.2 | 0.24 |
| Example 2 | 1.5 ± 0.3 | 0.65 |
| Comparative | 2.3 ± 0.4 | 1.00 |
| Example 1 | | |

It is clear that in the case that the inorganic layer of the present invention was used, the dark spots in the multicolor organic EL display was suppressed.

As described above, the inorganic layer as disclosed in the present invention can suppress the infiltration of moisture, which causes the deterioration in the characteristics of the organic EL light emitter. Therefore, it is possible to provide the multicolor organic EL display with the stable light emission characteristics for a long period of time. Further, because the inorganic layer disclosed in the present invention is manufactured with the CVD method, the productivity is greatly improved. As a result, the color conversion type organic EL display according to the present invention provides excellent reliability and productivity.

While the invention has been explained with reference to the specific embodiments of the invention, the explanation is illustrative and the invention is limited only by the appended claims.

What is claimed is:

1. A color conversion filter substrate, comprising:
a transparent support substrate,
at least one color conversion filter layer formed of a resin film containing a fluorescent colorant and formed on the support substrate in a desired pattern,
a polymeric layer having a flat surface and formed of a transparent material for covering the at least one color conversion filter layer and a surface of the transparent support substrate on which the color conversion filter layer is formed, and
a transparent inorganic layer formed on the polymeric layer and containing silicon and at least one of oxygen and nitrogen, said inorganic layer having a hydrogen-to-silicon atomic ratio less than 1.

2. A color conversion type multicolor display comprising: the color conversion filter substrate according to claim 1, a transparent electrode layer formed on the color conversion filter substrate at at least one electrically independent area, a light-emitting layer containing a light-emitting material and formed on the filter substrate, and a second electrode layer formed on the light-emitting layer.

3. A method of manufacturing a color conversion filter substrate, comprising the steps of:
preparing a transparent support substrate,
forming at least one color conversion filter layer formed of a resin film containing a fluorescent colorant on the support substrate in a desired pattern, covering the at least one color conversion filter layer and the transparent support substrate with a polymeric layer formed of a transparent material to be flat, and
forming a transparent inorganic layer formed of silicon and at least one of oxygen and nitrogen with a hydrogen-to-silicon atomic ratio less than 1 on the polymeric layer, wherein the inorganic layer is formed by using a plasma CVD method at a temperature of less than 200° C., using raw material gases containing at least a gas selected from the group consisting of silane and tetraethoxysilane, and a gas selected from the group consisting of nitrogen, ammonia, oxygen, nitrogen oxide and carbon dioxide.

4. A method of manufacturing a color conversion filter substrate according to claim 3, wherein in forming the inorganic layer, the support substrate has a potential lower than an earth potential.

5. A method of manufacturing a color conversion multicolor display, comprising the steps of:
preparing the transparent support substrate, forming, the at least one color conversion filter layer, covering the color conversion filter layer and the transparent support substrate with the polymeric layer and forming the transparent inorganic layer according to claim 3,
forming a transparent electrode at at least one electrically independent area on the inorganic layer,
forming a light-emitting layer containing a light-emitting material on the transparent electrode, and
forming a second electrode layer on the light-emitting layer.

6. A method of manufacturing a color conversion multicolor display according to claim 5, wherein in forming the inorganic layer, the support substrate has a potential lower than an earth potential.
